(19) United States
(12) Patent Application Publication
(10) Pub. No.: US 2010/0092617 A1
(43) Pub. Date: Apr. 15, 2010

(54) COMPOSITIONS COMPRISING POLYUNSATURATED FATTY ACIDS

(76) Inventor: Brian Anthony Whittle, Bedfordshire (GB)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/519,688

(22) PCT Filed: Dec. 17, 2007
(86) PCT No.: PCT/GB2007/004908

§ 371 Date: Dec. 29, 2009

(30) Foreign Application Priority Data
Dec. 18, 2006 (GB) 062608

(51) Int. Cl. A23L 1/0522; C09K 3/00; C11B 5/00; A23L 1/302; A23L 1/303; A23L 1/304; A23L 1/10; A21D 13/08; A23L 1/16; A23L 1/29; B65D 85/72

(52) U.S. Cl. 426/73; 252/182.12; 426/578; 426/541; 426/546; 426/72; 426/74; 426/549; 426/556; 426/557; 426/128

(57) ABSTRACT

The invention concerns compositions containing polyunsaturated fatty acids (PUFA's). More particularly it concerns a composition containing PUFA's, (particularly long chain PUFAs derived from marine sources, particularly fish, and its use in fortifying consumables, such as food, drink, supplements and nutraceutical or pharmaceutical products. More particularly it is a substantially non aqueous additive mix, for introducing poly unsaturated fatty acids into ingestible products, which when hydrated forms an oil in water emulsion, comprising one or more poly unsaturated fatty acids or a source thereof and one or more emulsifying agents. The mix can be added to, particularly farinaceous products, to provide PUFA supplementation.

### TECHNICAL FIELD

This invention concerns compositions containing polyunsaturated fatty acids (PUFAs). More particularly it concerns a composition containing PUFAs, particularly those derived from marine sources, particularly fish, but also algae, other micro-organisms and genetically modified plants, and the use of these compositions in fortifying consumables, such as food and drink.

### BACKGROUND OF THE INVENTION

Fortification of foods with PUFAs is recognized as an important measure to improve the nutritional well being of humans and animals. Several groups of PUFAs are ‘essential’ because they can not be synthesised efficiently by mammals and must be obtained from diet. Fish oils are an economic source of PUFAs but because of their origin can have a fishy taste. Previous attempts to solve this problem have involved enrobing particles of oil in a coating to mask the taste but the coating adds to the mass of material which needs to be added to give the required amount of LCPUFA. This is disadvantageous.

The invention follows from the discovery that products containing emulsified lipids in the form of oil in water emulsions have a different and generally less objectionable taste and mouth feel than products containing the same, un-emulsified oil. Provision of formulations which are substantially the non aqueous phase of an emulsifying system and which are self-emulsifying can be prepared using economic sources of marine lipids and lend themselves well to manufacturing processes. Significantly they also exhibit good stability.

### NOMENCLATURE

Edible fats and oils are glycerides of fatty acids (FA) and their characteristics are determined by their FA composition. Fatty acids are characterised by the length of the carbon chain, the number of unsaturated C—C bonds and their position in the molecule. Numbering the FA backbone starts at the lipophilic end of the molecule. This is designated ‘n’ in IUPAC chemical nomenclature. However, the Greek symbols ‘ω w or Ω’ are used in the scientific literature, interchangeably with the ‘n’ notation. Fatty acids are further defined by the position of the first unsaturated bond from the to end. Thus, Docosahexaenoic Acid, DHA, is 22:6 ω-3, a fatty acid with a carbon chain length of 22, with six double bonds recurring at 3 carbon atom intervals, the first of which is between carbons 3 & 4.

The carbon chain length of FA's in foods varies from 8-14 up to 20-24 or more (long chain fatty acids, LCFAs). Fatty acids with a chain length of 16 and 18 are the most abundant in foods. The nomenclature of the fatty acids is illustrated below with reference to shorter chain FA's with a chain length of 18 carbon atoms.

Short Chain Polyunsaturated fatty acids (SCPUFAs) with a carbon chain length of 18 or less:

| Class | Designation | Common Name | Derivation |
|---|---|---|---|
| Omega 9 | 18:1 ω-9 | Oleic Acid | Olive oil |
| Omega 6 | 18:2 ω-6 | Linoleic acid | Seed/nut oils |
| Omega 3 | 18:3 ω-3 | α-Linolenic acid (ALA) | Seed/nut oils |
| Omega 3 | 18:4 ω-3 | Stearidonic acid (SDA) | Seed oils |

Long Chain polyunsaturated fatty acids (LCPUFAs) with a carbon chain length of 20 or more:

| Class | Designation | Common Name | Derivation |
|---|---|---|---|
| Omega 3 | 20:4 ω-3 | Eicosatetraenoic acid | Marine oils |
| Omega 3 | 20:5 ω-3 | Eicosapentaenoic acid (EPA) | Marine oils |
| Omega 3 | 22:5 ω-3 | Docosapentaenoic acid (DPA) | Marine oils |
| Omega 3 | 22:6 ω-3 | Docosahexaenoic acid (DHA) | Marine oils |
| Omega 3 | 24:6 ω-3 | Tetracosahexaenoic acid | Marine oils |

Saturated C16 and C18 fatty acids e.g. Palmitic and Stearic acids occur both in animal and plant derived fats and can be desaturated by mammals. For example Stearic acid is desaturated in mammals to give oleic acid (C18:1 ω9). The marine PUFAs e.g. EPA, DPA and DHA, by way of contrast, contain long chain fatty acids with a carbon chain length of C20-22 respectively. Mammals, and in particular humans, cannot produce the LCPUFAs by further de-saturation of ω-9 fatty acids, nor chain-elongate ω3 and ω6 plant derived fatty acids efficiently. These essential LCPUFAs must therefore be obtained from diet, and marine lipids are a suitable economic source.

Modern lifestyles and dietary habits have tended to reduce the amount of LCPUFAs in diet. There are a number of problems in human dietary intake and metabolism which can be alleviated by the administration of appropriate supplements of PUFAs. These include:
Improving the consumption levels of ω-3 fatty acids to meet guideline intakes (ω-6 intake is usually adequate)
Improving the ratio of Omega 6 to Omega 3 PUFAs in diet from 12:1 (the European average) to about 6:1; and
Correcting the levels of the long chain to ω-3 fatty acids (particularly C20, and C>22) fatty acids present in the diet.

The important long chain LCPUFAs are obtained almost exclusively from organisms in the marine food chain. LCPUFAs are produced in plankton and other simple marine organisms, and are the starting point of the food chain which has fish and whales at its apex. Fish are an economic source of LCPUFA-rich oils. However, LCPUFAs can be produced from natural or genetically modified micro-organisms. Omega-3 oil from this source is a suitable source of oil in the present invention, albeit at a higher monetary cost. Highly refined sources of LCPUFAs which are also suitable for inclusion in the formulations of the invention include the methyl esters of LCPUFAs which are available commercially, but generally at higher costs than refined marine oils. Genetic modification programmes seek to provide LCPUFAs from plant sources, and refined lipids from any of these sources when available in quantity at an economic price, are suitable starting materials for products of the invention. The cost of the starting material for food additives is of practical concern and generally, the processes of the invention allow for use of an economic source of refined marine oils or synthetic derivatives. This can be done without compromising taste or other organoleptic criteria.

Practical Levels of Fortification

There is at present no regulatory Recommended Daily Allowance for ω3 LCPUFAs but the recommended intake (Recommended Daily Intake, RDI) is currently 450 mg per day for adults. Doses of 3000 mg per day may be given for the treatment of hypertiglyceridaemia as a proprietary prescription product under medical supervision. Products produced using the formulations described in the invention, are intended to be incorporated into foods at the rate of 5-500 mg and preferably 50-100 mg per serving. At this range of incorporation the flavour characteristics of the product are not compromised. The amount of ω-3 PUFA per serving of product can be adjusted by variation of the rate of incorporation and the size of serving to meet present or future recommendations on dosage.

A problem encountered in the use of marine oils, particularly deep-sea fish oil, is the characteristic ‘fishy’ taste which limits supplementation in food and beverage products. ‘Off flavours’ are made worse by oxidation. The high degree of unsaturation which is a feature of unsaturated oils may lead to peroxidation and rancidity if the oils are exposed to the air or oxidising agents. Besides ‘fishy’ taint and metallic flavours, free radicals and reactive aldehydes and other oxidative degradation products may be produced by interaction with oxygen and may have adverse effects on human health. The development of ‘off flavours’ can be minimised or prevented by processing and packaging under nitrogen, and ensuring that there is minimum ullage in packs.

Previous attempts to solve these problems have been partially successful. One novel food ingredient—a microencapsulated powder contains about 1/7 by weight of ω-3 PUFA as fish oil. The objectives were partially attained by microencapsulation whereby the fatty acids were surrounded by milk proteins, gelatine and other excipients, and then dried to a powder. The size of the droplets and homogenisation are stated to be critical stages of the procedure since the less trapped air, the less oxidation will take place. However, such processing renders the end product too expensive for addition to many staples in effective quantities.

The problems which remain therefore are the preparation of an ingredient which does not have a “fishy smell”, survives conventional cooking processes and which has a reasonable shelf life. Compositions which are perceived not to contain additives (E Nos) are (even if irrationally) preferred by consumers.

Overall, it is convenient to provide 10-250 mg of LC PUFAs by reference to 100 g or 100 ml of food product. This can be done by incorporating a defined proportion (0.1 to 2.5% by weight) of uncooked ingredients. By adjustment of the rate of incorporation, the required amount of ω3 fortifications to meet current and future Recommended Daily Allowance (RDA) or the current Recommended Daily Intake (RDI) can be accommodated.

Other prior art identified by the applicant includes:

WO 2007/005725, which is directed to producing a solid fat composition comprising mixing an oil comprising saturated fat and a microbial oil with an emulsifier. Microbial oils, whilst containing LCPUFA's do not exhibit the taste/smell problems associated with marine oils;

EP1548093, which is directed to an oil-in-water emulsion in contrast to the non-aqueous additive mix of the invention;

EP1710296, which is directed to fat compositions containing phospholipids and LCPUFA's;

GB2140806, which is directed to a method of stabilising fish oils using phosphatide compounds;

U.S. Pat. No. 7,045,143, which is directed to specific blends of lipids and their use in treating inflammatory diseases; and

US 2003/0044490, which discloses a dry powder composition in which polyunsaturated fatty acid is encapsulated in a matrix comprising starch hydrolysate and malto-dextrin.

None of this art discloses a simple, cost effective, non-aqueous additive mix, including relatively high proportions of marine oil, in a form suitable for dosing food and beverages which has an acceptable shelf life.

### PRESENT INVENTION

The object of the present invention was to develop an alternative product and method of manufacture which overcame the problem of a ‘fishy smell’ or taint and provided a product which, with minimal (15% or less) or no inclusion of ingredients deemed to be ‘synthetic’ (e.g. glycerol monostearate), was suitable for dosing into consumable products in a cost effective manner and which had a commercially acceptable shelf life.

Forms suitable for both liquid and solid dosing were desirable.

It was noted that palatability and ‘mouth feel’ of fish oil formulations could be improved by making them into an oil-in-water (o/w) emulsion. Further improvement in palatability (and improved shelf life) was effected if the emulsion was not pre-formed, but was generated extemporaneously during preparation of the mix. This was achieved by providing a substantially non-aqueous composition which emulsified easily when brought into contact with water or the aqueous components of the formulation and subjected to the normal mixing process.

According to the present invention there is provided a substantially non aqueous additive mix, for introducing poly unsaturated fatty acids into ingestible products, which when hydrated forms an oil in water emulsion, comprising one or more poly unsaturated fatty acids, methyl esters thereof, or a source thereof and one or more emulsifying agents.

The choice of emulsifier(s) is based on the consistency and mixability required for efficient operation. More particularly the additive mix comprises one or more LCPUFAs or a source thereof that are not coated, powdered and/or spray dried.

The mix preferably takes the form of a paste whose viscosity can vary from that comparable to double cream (readily flowable) through something with the viscosity of a soft margarine (pasty) to that of a solid with the consistency of marzipan, in which case it can be provided in the form of a block or as granules. The paste presentation is a convenient format for bread and cake mixes. A granulate is an appropriate form as part of a dry mix formulation intended for subsequent reconstitution.

Preferably the one or more poly unsaturated PUFAs or a source thereof are of marine, fungal, microbial or genetically modified origin, including concentrates thereof, and the PUFAs are present as triacylglyerols, or esters, in an amount of from 10 to 80% of the total weight. Ideally the ingredient of the invention should include as high an amount by weight as possibly, preferably at least 20% by weight through 30% and 40% to 50% or more. This compares favourably to the approx 15% achieved by enrobing oils in a protein coat.

The emulsifying agent may be present in an amount of from 0.25 to 40% by weight, preferably 0.5 to 20%, more preferably 1-10% by weight and most preferable around 2.5 to 5%. The emulsifying agent may be formed de novo from at least one of the constituents e.g. soya flour. A primary and/or secondary emulsifier may be used.

Whilst the glycerols are particularly good (primary) emulsifiers, many people would prefer not to include, e.g. glycerol monostearate (GMS) and other acyl glyceryl esters. Accordingly, in some embodiments what might be termed a secondary emulsifier e.g. Soya lecithin (and Soya flour whose primary use is as a viscosliser) may be the only emulsifier present.

The use of GMS as the sole emulsifier in the formulation can lead to a low viscosity product at room temperature. This latter problem can be mitigated, to some extent, by selecting GMS grades based on hard fats and adding edible hard fat as filler. A harder product can also be made by increasing the amount of Soya Flour, or other powder filler.

In a particularly favoured embodiment, the additive mix of the invention contains natural flour lecithin's, particularly soya lecithin, to the exclusion of GSM.

It has further been determined (see Example 7) that quite small quantities of GMS are sufficient to produce an emulsifying effect, and these can be generated in situ in Soya and other flour preparations.

Soya flour contains triglycerides but little or no mono- and di-glycerides. It also contains lecithin which can act as an emulsifier. Native Soya flour contains lipases which are inactive in the dry state. They can be activated by moisture, surfactants such as bile acids and acids. It has been found, by experiment, that activation of lipases in Soya flour, under defined conditions, leads to the production of a mixture of mono and di-acyl glycerol esters from triglycerides. It is therefore possible to produce an efficient emulsifying system containing sufficient GMS by causing interaction of lipase and the triglyceride in Soya flour by for example the addition of an acid.

The use of an aqueous acid is an effective means of activating lipases, and after incubation, the reaction can be stopped by neutralisation of the acid, heating, and drying. Conditions in which this reaction can be carried out at bench scale are described in Example 7. Larger scale manufacture can be effected using equipment such as heated roller dryers and mixer granulator dryers which are standard food manufacturing equipment.

Other components such as an antioxidant and filler or viscosifying agent may also be added in amounts to 50%. The addition of an antioxidant in an effective amount (which varies with the one or more anti-oxidants selected) assists prolong shelf life.

Preferably the one or more PUFAs or a source thereof are provided by an oil such as blended, pressed, deodorised, or concentrated oil derived from fish, algae, other microorganisms or from genetically modified plants. A fish oil containing a good source of EPA and DHA is preferred. Alternatively the PUFAs may be provided as alkyl esters of LCPUFAs.

The emulsifying agent may be selected from mono, di- and tri-acyl glycerols, most preferably having a chain length of from C6 to C24, preferably one rich in the long chain PUFAs. Alternatively, or in addition, a lecithin may be used. The lecithin may be an egg lecithin, milk lecithin or a Soya lecithin (E322), native or heat treated, or a food component containing a lecithin from a seed or bean such as, soya bean, peanut, cottonseed, sunflower, rapeseed, corn, or groundnut oil.

Preferably a semi-liquid or liquid lecithin obtained from sunflower seed can be used as emulsifier.

Where a filler or viscosifing agent is incorporated it may be incorporated in amounts of up to 87.5% by weight. The preferred fillers are wheat flour, Soya flour or bean flour.

Where the mix is used to fortify farinaceous products a grain or seed flour is preferably used as the viscosifying agent—Soya flour is preferred, again either native, heat treated or toasted. Alternatives may include Vicia Faba Major (Broad bean), Equina flour (Horse bean), Gram flour (chick pea), and pea flour.

The inclusion of a filler, viscosifying agent or bulking agent ensures the mix is in a form suitable for dosing and handling. Ideally a pasty consistency is preferred such that the mix has a processing viscosity similar to that of double cream or margarine.

Increasing the proportion of filler, viscosifying agent or bulking agent produces a solid which can be granulated. The granules can be classified by sieving and are particularly suitable for inclusion in dry powder mixes.

It may also be desirable to include other “additives” in amounts that will fortify an end product. Such additives may include:
Fortifying amounts of one or more vitamins, particularly the fat soluble vitamins: vitamin A, vitamin D, and Vitamin E;
Minerals, particularly a source of calcium, a source of magnesium (both important for teeth and bone well being); iron as reduced iron powder or at least one of its nutritionally acceptable salts and optionally, one or more trace elements;
Antioxidants to prevent oxidative deterioration such as mixed natural tocopherols (E306) or natural rosemary extract (flavour). Citric Acid (Anhydrous) can also be used as an antioxidant and sequestering agent.

Optionally, the product of the invention can be combined with the other components of Improvers used in commercial production. Proprietary Bread Improvers contain ascorbic acid which modifies elasticity of the dough, dough lubricants and food oils. Some of these functions are additionally provided by the products of the invention and it is convenient to include these elements in a single additive.

The substantially non aqueous additive mix of the invention can be added to a wide variety of products to provide fortifying amounts of PUFAs and other ‘additives’ which promote well being.

Typical farinaceous products include raised products such as breads and pizza bases, other bakery products such as morning goods, cakes, muffins, doughnuts, and biscuits (fruit and fibre based) as well as unleavened products such as, naan bread, chapattis, tortillas and wraps. Other examples include dried doughs such as noodles and pasta.

The substantially non aqueous additive mix can also be added to beverages including milk, smoothies, soups and soft drinks, as well as to milk products and confectionery. For incorporation into dry mixes intended for extemporaneous preparation of instant soups and drinks, a granulate form is suitable.

According to a further aspect of the present invention there is an ingestible product produced by addition of an additive of the invention thereto.

According to a third aspect of the present invention there is a method of fortifying an ingestible product with a PUFA comprising adding the substantially non aqueous additive mix of the invention during the processing of the ingestible product in an amount which will provide the finished product with a known amount of PUFA in a given weight or volume.

This may be done to promote a nutritional or health benefit such that the product is labelled to indicate a unit dose (e.g. two slices of bread) will provide the equivalent of a quarter of the daily recommended dose of e.g. omega 3.

According to a fourth aspect of the present invention there is a method of generating a natural emulsifier from a farinaceous product comprising activating natural lipases present therein to generate a mixture of emulsifying mono and di-acyl glycerol esters from triglycerides naturally present therein.

This can be done by, for example, acidification and subsequent neutralisation.

In a favoured embodiment the substantially non aqueous additive mix of the invention has been designed specifically for use by bakers. Accordingly, it is desirable that the bakery formulations are easily handled at ambient room temperatures. Ideally they are sufficiently viscous to be scooped and weighed but have a soft texture which blends easily with other ingredients.

Viscosity and melting point may also be adjusted by adding other ingredients in the form of fine powders.

Hydrogenated and partially hydrogenated cottonseed, palm and soybean oil, prepared by catalytic hydrogenation have high melting points. These semi-synthetic fats may be used to modify the rheology of pharmaceutical products. However, the use of converted food ingredients in nutritional products is considered undesirable by some consumers, since catalytic hydrogenation results in the formation of trans-orientated fatty acids which have been associated with an increase in LDL levels in blood and cardiovascular complications. For this reason and because of consumer aversion to synthetic ingredients, their use in nutritional products is not favoured.

Alternative methods of adjusting viscosity are by addition of a proportion of very finely divided floury food ingredients, and or the addition of higher melting (hard) fats.

The applicant has determined that the addition of a quantity of 1-50% of hard fat, and preferably 5-30% of stearin, produced an optimum viscosity, as measured using a conventional cone penetrometer at ambient room temperature (24° C.±5° C.).

Stearin fractions are produced commercially by cooling oils to a low temperature (0° C. to −20° C.), so that the compounds with the highest melting points precipitate, and can be removed by centrifugation or filtration. In manufacture, the removal of stearin by this procedure is known as ‘Winterisation’, and the process is widely used in clarifying food oils. Stearin fractions contain saturated triglycerides of long chain fatty acids, and related esters, and can be used in the same way as other hard fats to adjust the rheology of food formulations.

Stearin, such as that obtained by winterisation of palm oil can be used to increase the viscosity of compositions of the invention at proportions similar to those employing hydrogenated fats and have proved particularly beneficial.

The various aspects of the invention are further described with reference to the following examples:

### DETAILED DESCRIPTION

In its simplest form the additive composition of the invention may comprise
a) a PUFA source, for example, a fish body oil or a blend of refined fish body and fish liver oils;
b) at least one emulsifying agent, which also adds viscosity to the mix; and optionally
c) a filler, which adds viscosity and texture to the mix and which may also contribute to the functions of a), b) and d);
d) an antioxidant to prevent oxidation of the PUFAs and the mixture; and
e) other nutritional enhancing components e.g. minerals, trace elements and vitamins.

The filler c) may additionally contain a proportion (e.g. 5-10% of its weight) of natural emulsifiers.

Preferably a) the PUFA source contains between 10-80% of a marine oil and more preferably is present in an amount of from 25-60%. It is desirable to maximise this component and amounts of greater than 30%, through 40% to 50% or more are more preferable.

Preferably b) the at least one emulsifying agent or a blend thereof is present in an amount of from 0.25%-40%, more preferably from 1% to 40% and typically from 1 through 2.5%-15% by weight; Suitable emulsifiers are identified in Table 1.

The type of emulsifier selected will depend on the set characteristics of the mix and the food products into which the ingredients are added. Generally, a high melting point emulsifier will produce a more solid product, suitable for granulation; conversely a low melting point emulsifier will facilitate dispersion in liquids at low temperatures.

TABLE 1
EMULSIFIERS

| | Abbre- | E | |
|---|---|---|---|
| Name | viation | Number | Additional Function |
| Citric acid esters of mono | CITREM | E 472c | Control of flow |
| and di acylglycerols | | | properties/reduce |
| | | | yield value and |
| | | | plastic viscosity; |
| | | | antioxidant |
| Di-acetyl tartaric esters of | DATEM | E 472e | Interact with gluten to |
| mono and di acylglycerols | | | strengthen dough in |
| | | | yeast raised products |
| Distilled Mono | DGMS | E 471 | Prevent staling and |
| acylglycerols | | | sticking in bread/ |
| | | | pasta |
| Mono and di acylglycerols | GMS | E 471 | Shortening/emulsifier |
| Mono and di acylglycerols | AL-GMS | | Shortening/emulsifier |
| formed by the action of | | | |
| activated lipase on | | | |
| intrinsic triglycerides (AL- | | | |
| GMS) | | | |
| Sunflower Lecithin | SFL* | E 322 | Emulsifier |
| Soya Lecithin | SYL | E 322 | emulsifier |
| Sorbitan esters of | | | |
| acylglycerols: | | | |
| Sorbitan monostearates | SMS | E 491 | Fat crystal |
| Sorbitan tristearates | STS | E492 | modification e.g. |
| | | | prevent oil clouding, |
| | | | chocolate bloom, |
| | | | grainy margarine |
| Stearoyl lactylates: | | | |
| Sodium stearoyl lactylates | SSL | E481 | Interact with gluten to |
| Calcium stearoyl lactylates | CSL | E482 | strengthen dough in |
| | | | yeast raised products |

*Similar lecithin fractions suitable for this function can be obtained from peanut, cottonseed, rapeseed, corn, or groundnut oils.

Preferably the filler c) also functions as an emulsifier and may be present in an amount of up to 87.5% depending on its function and the amount and type of emulsifying agent it naturally contains. The filler may be at least one of wheat flour, defatted pea flour, gram flour or other bean flour such as carob bean flour.

For convenience of use, the non aqueous additive mixes of the invention take the form of soft pastes or granules for immediate incorporation into mixes or as granulates in products to be later reconstituted at will. Their non aqueous nature enhances shelf life, and discourages growth of vegetative micro-organisms.

Preferably d) an effective amount of pharmacologically acceptable antioxidant is added in a concentration from 0.01% to 2%, more preferably 0.01 to 1% depending on the anti oxidant(s) selected. Suitable antioxidants are mixed natural tocopherols (E306); dl-alpha-Tocopherol (E307); ascorbyl palmitate or stearate (E304 & E310); natural rosemary extract (which may also serve as a flavouring agent and is generally used in higher amounts being an extract) or ascorbic acid (E300). NL331A is a blended fish oil to which antioxidant has been added as a chemical preservative during manufacture.

e) Optionally, additional nutritionally beneficial components may be included, such as, for example, minerals, vitamins and trace elements.

Preferably, the compositions of the invention comprise in addition to components a) and b), a viscolising agent, most preferably a stearin, and an antioxidant.

A range of additives (A to H) for introducing PUFAs into food and beverage products is described in Example 1 below:

### Example 1

Non Aqueous PUFA Mixes

A range of compositions A-H were prepared, using two alternative commercially available marine oils, and a range of excipients. Other refined marine oils can be used, adjusting the quantities to take account of the content of ω-3. These are set out in Table 2 below:

TABLE 2
Formulations

| | | | | | | D | E | F | G | H |
|---|---|---|---|---|---|---|---|---|---|---|
| | | | A | B | C | Wt | Wt | Wt | Wt | Wt |
| Component | Function | Range | Wt (g) | Wt (g) | Wt (g) | (g) | (g) | (g) | (g) | (g) |
| a) Fish Oil | PUFA source | 10-80% | 50 | 33.3 | 25 | | | | | |
| HB 7310 | | | | | | | | | | |
| Fish Oil | PUFA source | 10-80% | | | | 50 | 50 | 50 | 50 | |
| NL331A | | | | | | | | | | |
| Fish Oil | PUFA | 10-90% | | | | | | | | 75 |
| NL 331A | source | | | | | | | | | |
| b) Mono-di-& tri- | Emulsifier | 2.5-40% | 5.5 | 5.5 | 10 | 10 | | | | |
| acyl glycerols | | | | | | | | | | |
| IGMS | Emulsifier | 2.5-60% | | | | | 5.0 | | | |
| e) Calscience ® | Mineral additive | Typically 10-20% | 16.7 | 16.7 | 16.7 | | | | | |
| b) Soya Lecithin | Secondary | | 6.0 | | | | 1.5 | 2.5 | 2.5 | 9.5 |
| | Emulsifier | | | | | | | | | |
| c) Soya Flour | Viscoliser | | 12.0 | 29.4 | 30 | 35 | 40 | 26.4 | 32.4 | |
| | containing a | | | | | | | | | |
| | 2° emulsifier | | | | | | | | | |
| Hard Fat | Viscoliser | | | | | | 3 | 20 | | |
| c) Vegetable Oil | Excipient | | 9.6 | 15 | 2.9 | 4.8 | | | 14.5 | 15 |
| d) Rosemary | Antioxidant | | 0.2 | 0.1 | 0.4 | 0.2 | 0.5 | 1.0 | 0.5 | 0.5 |
| Extract | | | | | | | | | | |
| d) Citric Acid | antioxidant | | | | | | | 0.1 | 0.1 | |
| (Anhydrous) | | | | | | | | | | |
| TOTAL | | | 100 | 100 | 100 | 100 | 100 | 100 | 100 | 100 |

Table 2 gives specific formulations. It is within the scope of the specific formulations to cover similar formulations with a range spanning from plus or minus 5%, through 10% and 15% to 20% of each component (type) indicated.

In the examples A-H above the consistency varies and is largely dependant on the quantity of Soya flour added and the melting point of the emulsifier used. Soya flour is a particularly useful diluent because it also contains an emulsifying agent and C18 ω-3 PUFAs (5-10% of the oil). Other flours are suitable for this purpose.

Mix A is a creamy mobile suspension;

Mix B has the consistency of a soft margarine;

Mixes C and D have the consistency of marzipan;

Mix E has a firm consistency;

Mix F has the consistency of a soft margarine at room temperature;

Mix G is a creamy liquid; and

Mix H is a liquid suitable for dosing into beverages including milk.

All of the mixes have the property of being capable of blending readily with each other and with other ingredients; the significant difference is in their physical properties and handling characteristics.

Mixes A and H have been used in drinks and beverages where, and with appropriate agitation, they form a stable emulsion in products such as fruit juices, ‘smoothies’, milk and dairy products.

The less viscous mixes can also be used in the manufacture of pasta where it is desirable to have a mix which will readily mix with other liquid components before the addition of flour or semolina.

Mixes C & D are used as a component of cake and pudding mixes for immediate use. The mixes can be pushed through a coarse sieve to produce granules. The resulting granules can also be used in dry mixes and stored in sealed containers until required for reconstitution to produce bread products, cakes or pudding type deserts.

Mix D illustrates the use of refined fish oil where the content of vitamins A and D has been reduced so that greater quantities of fish oil can be administered without the risk of overdosing on these vitamins. NL331A is a proprietary purified blended fish lipid containing antioxidant which has a high LC ω-3 content. Other blended purified fish oils, with different ω-3 content can be used with appropriate adjustment of the amount of fish oils and vegetable oil to give the desired ω-3 content.

Mixes E to G are compositions which vary in terms of the nature and quantity of viscolising agent. Each of these formulations was fit for purpose as an ‘improver’; for bread dough. Viscosity/texture increased in the order G, E, F.

A quantity of 2 grams of mixture C provides approximately 75 mg of Calscience® (a blend of calcium and magnesium as described in GB2341798) and 150 mg of total Omega 3 PUFAs, of which 80% is EPA/DHA.

Refined fish oils are available commercially and grades for use in the products of the invention are selected according to their taste and general palatability. The fish oils used in Example 1 are HB7310 a blend of cod liver oil and fish body oils, and NL331A—refined fish body oil. Both oils have a weight/ml of 0.92. All quantities are expressed by weight in grams. Table 3 below sets out their respective compositions in more detail:

TABLE 3
Composition of Selected Marine Oils

| | HB 7310 | | NL331A | |
|---|---|---|---|---|
| | ω3 content | | ω3 content | |
| COMPONENT | mg/10 ml | mg/10 g | mg/10 ml | mg/10 g |
| EPA & DHA | 2750 | 2989 | | |
| EPA & DHA | | | 3000 | 3260 |
| Vitamin A | 1300 μg | 1413 μg | NMT* 100 | |
| | (4,300 IU) | | IU | |
| Vitamin D | 10 mg | 10.86 mg | NMT 100 | |
| | (400 IU) | (434 IU) | IU | |
| Vitamin E | NLT** 20 IU | | NLT** 20 | |
| | | | IU | |

*NMT—not more than,
**NLT—not less than

Examples 2 to 6 below exemplify how a non aqueous additive mix of the invention can be used to provide fortifying amounts of PUFAs, and other component e.g. minerals and vitamins, to ingestible foods and beverages.

### Example 2

PUFA Fortified Cakes, Pudding or Desert

Quantities are given by weight for a unit serving, and the component mix is detailed in Table 4 below:

TABLE 4

| | | Range | Quantity |
|---|---|---|---|
| COMPONENT | FUNCTION | (%) | (g) |
| Wheat flour | Farinaceous | 30-80 | 22 |
| | Base | | |
| Granulated Sugar | Sweetener | 5-20 | 6 |
| Palm stearin/ | Shortening | 1-15 | 2.0 |
| Vegetable Oil Mix | | | |
| Dextrose | Sweetener | 1-20 | 2 |
| Poly-dextrose | | 1-20 | 1 |
| Baking Powder | Raising Agent | 0.1-3 | 1.5 |
| Corn flour | | | 3 |
| Salt | | | 0.5 |
| Flavouring | | | 0.1 |
| Dried Egg Powder | | | 3 |
| Mixture C | | | 2 |
| Water (Room | | | 15 |
| Temperature) | | | |
| Boiling Water | | | 15 |

The “instant” cake (pudding or desert) can be prepared as follows: 2.1 The dried ingredients are thoroughly mixed.

At this stage, the dry product can be stored in a sealed container intended for eventual use of the product. Suitable disposable containers are available commercially. Those formed from hardened cartridge paper are suitable for microwaving and heat-resisting copolymer containers are suitable for cooking in an oven;

2.2 The water (room temperature) is added to the mix;

2.3 The boiled water is then added to the mix; (Addition of boiled water in the manner described raises the temperature of the mixture to about 60° C., so that the cooking process starts immediately. Hot water also facilitates mixing of the ingredients);

2.4 The mixing may be carried out in a container and transferred to the cooking container. Alternatively, and more expeditiously, the mixing can be done in the final cooking container.

2.5 The product is cooked in a microwave oven at e.g. 900 W power for 30 seconds. Within a few seconds, the mix expands to fill the container and is cooked in a relatively short period of time, recognisable by the dull appearance of the surface of the product.

Alternatively, the product can be baked in a conventional oven at e.g.180° C. for approximately 10 minutes to produce a small cake.

The resulting product has a firm texture, and occupies a cooked volume of 160-210 ml. The consistency can be varied by adding a further quantity of 5-10 ml water per portion at the mixing stage if, for example, a softer product, as in the case of a pudding, is required.

Addition of e.g. 10 g of cooked fruit or jam to the product immediately before cooking results in a dessert which can be eaten either from the container or turned out in the conventional way onto a plate. The fruit or jam falls to the base of the product, or can be swirled into the mix immediately before cooking to produce a decorative feature.

Adding moderately hot water (40°-50° C.), speeds up preparation of the dessert. Hot water not only improves mixing but also facilitates the emulsification of the additive as well as shortening the cooking process. Cold water mixes less readily. However, cold water can be used, but longer cooking times are required.

The resulting product (a single serving) contains approximately 75 mg of a mixture of calcium and magnesium, and 150 mg of Omega 3 PUFAs. This rate of addition does not compromise the texture or taste of the product, and is an acceptable way of introducing ω-3 PUFAs into the diet. The formulation in Example 2 has a low fat content. The addition of shortening up to a total of 12% w/w will produce a richer ‘Victoria Sponge’ type of texture.

Importantly, no unacceptable fishy taint is detectable in the products at this level of inclusion. Without prejudice to the teaching of the patent, it is considered that emulsification or adsorption of the fish oil from the components of the mixes described in Example 1 alter the mouth feel and taste perception which may be characteristic were plain fish oil to be added. It is also possible that the cooking process also allows any fish taint to be ‘blown off’ or evaporated from the mix.

Obviously, different dietary requirements can be met by altering the proportion of the additive or using an additive with different ingredients or amounts, taking account of the starting content of ω-3 PUFAs, vitamin and mineral content of the other ingredients.

Testing by a taste panel confirmed that no detectable fish taint was identified in the product described in the examples. In the comparator product, the fish oil component was replaced with an equivalent amount of a vegetable oil.

### Example 3

PUFA Fortified Bread

The components were as set out in Table 5 below: quantities are in grams for solids and mls for liquids.

| | | | | White | White |
|---|---|---|---|---|---|
| COMPONENT | FUNCTION | Range | Wholemeal | (a) | (b) |
| Wholemeal | Base | | 5000 | | |
| flour | | | | | |
| White flour | | | | 5000 | 5000 |
| Wheat germ | | | | 50 | 14 |
| White Wheat | | | | 10 | 40 |
| fibre | | | | | |
| Water | | | 2850 | 2850 | 2850 |
| Vinegar | Fungicide | | 62 | 62 | 62 |
| Proprietary | | | 138 | 138 | 138 |
| Bread | | | | | |
| Improvers | | | | | |
| Brine | Seasoning | | 288 | 260 | 260 |
| Liquid yeast | | | 220 | 220 | 220 |
| Mixture D | | 5-250 | 50 | | |
| Mixture F | | 5-250 | | 100 | |
| Mixture G | | 5-250 | | | 100 |

The bread can be prepared as follows:

3.1 The dry ingredients are mixed thoroughly.

3.2 The liquid ingredients, together with mixture D, F or G, are blended with a small proportion of the water and diluted with the remainder before adding to the dry ingredients.

3.3 Thereafter the spiral mixing process (typically 2 minutes at slow speed, 10 at fast speed) is as conventionally undertaken for bread and dough to the appropriate end point temperature.

Weighed portions of dough are kneaded and divided for intermediate proving prior to shaping and moulding (approximately 12 minutes). The dough pieces are then placed in baking tins in the conventional way and proved in a temperature and humidity controlled environment for about 40 minutes. They are then baked at 225° C. for 26 minutes.

The resulting loaf is indistinguishable from conventional loaves of the same type, ie white or Wholemeal, in which mixture D, F or G is replaced with an equivalent quantity of sunflower oil. The quantities given above will produce approximately 10 loaves, each with a cooked weight of about 800 grams. When sliced, two slices (c. 88 g) provide approximately 90 mg or 180 mg (depending on the rate of incorporation of Mix) of Long chain Omega 3 PUFAs and a similar proportion of the RDA for calcium, and about twice that for magnesium. It will be obvious to one skilled in the art that the amount of nutrients can be adjusted by varying the rate of inclusion of e.g. mixes D, F or G.

Bread mixes containing wholemeal flour, or 0.5 to 10% of wheat germ and white wheat (or bamboo) fibre in addition to white flour, are particularly useful for masking the taste of fish oil products. They allow the incorporation of proportionately greater amounts of products of the invention without compromising flavour characteristics of the bread.

In some cultures, the predominant dietary staple is a product such as Chapatti or Naan Bread. These products are produced commercially, but are more commonly produced as domestic products made extemporaneously from flour and water. Chapatti flour produces elastic dough when mixed with water and kneaded. The dough contains a small quantity of shortening in the form of oil. By experiment it has been found that mixture A can be used in manufacture of Chapattis to give a product which has the same physical characteristics as conventional Chapattis but can also provide Omega 3 PUFAs, together with minerals, such as Calcium, Magnesium and Iron. The fortification of staples is a convenient way of adding these essential minerals to a diet, and a program for mineralisation of such products is supported by several government agencies.

Example 4 illustrates the manufacture of Chapattis using the ingredient of the invention. It will be obvious that the teaching of the patent can be applied to the enrichment of other farinaceous staples such as noodles, pasta, tortillas, wraps and pizza bases. Incorporation of ω-3 marine oil and minerals is particularly useful in populations where oily fish is not readily available or it is undesirable for ethical and cultural reasons.

### Example 4

Mineral and ω-3 PUFA Fortified Chapattis.

The components were as set out in Table 6 below:

| COMPONENT | FUNCTION | Range | Quantity (g) | |
|---|---|---|---|---|
| Indian Wheat Flour | Base | | 100 | g |
| Reduced Iron | Mineral additive | | 8 | mg |
| Water | | | 40 | g |
| Mixture A | PUFA | | 1.5 | g |
| Sunflower Oil (or | Lubricant | | 8.5 | g |
| Ghee) | | | | |

The Chapatti can be prepared as follows:

4.1 The mixture A and the oil are mixed and stirred into the water using a mechanical stirrer to produce an emulsion.

4.2 The resulting emulsion is then used to slake the flour and is mixed to give a stiff dough.

4.3 The resulting dough is thoroughly kneaded. This quantity will make 12 small chapattis or 6 parathas. This quantity is normally sufficient for about 3 persons.

The divided pieces of dough are rolled out and flattened using a little dried flour to prevent sticking and rolled out to a thin pancake of about 15 cm in diameter. The pancakes are then placed on a hot griddle over a high heat. When brown spots appear the chapatti is turned over and cooking completed on the other side, pressing down with a spatula or spoon if necessary. The process can be repeated once more so that the chapatti is cooked evenly on both sides. Normally, chapattis are prepared extemporaneously, as required.

Naan bread can be made in a similar way using conventional methods, the essential difference being the use of mixture A which provides mineral and Omega 3 fortification and makes a contribution to the total amount of shortening conventionally used in the manufacture of such products. Traditionally, these staples are prepared in the home, and the ingredients for making them can be assembled into a kit. In this case, the additives are provided in a dispenser designed to minimise exposure to air, or in unit dose sachets of conventional design.

The additives of the invention can be used to produce a variety of deserts as illustrated in Examples 5.

### Example 5

Cold Dessert—Mousse

A cold dessert can be prepared using a cake base on which an emulsified mousse is added and decorated with, for example, fruit and covered by a decorative glaze. The cake base is made as described in Example 2. The construction of the mousse, the decorations and glaze allow additional nutritive elements to be introduced into the confection.

The cold desert can be assembled by adding a layer of mousse on the cake base. The mousse contains sufficient Mix A (0.3-0.5 g) to give approximately 50 mg LCPUFA per portion. The possibility of dividing the ω-3 content between the base and the topping provides additional options in dosing without compromising the taste and texture.

It will be obvious that other conventional types of confectionary can be fortified by the use of ω-3 mixes described herein. The mixes blend well with cheese cake and cream compositions and cake bases used in the assembly of confectionery items. The mix of Example 1 can also be used to impart PUFAs into beverages:

### Example 6

### PUFA Fortified Smoothies

The mixes described in Example 1 are essentially the disperse phase of an o/w emulsion which forms an emulsion when it mixes with water. Smoothies are homogenates of fruit, with optional stabilisers and sweetening agents. 0.33 g of mix A was added to an aliquot of a 200 ml serving of a pineapple banana apple coconut and orange juice Smoothie (giving an equivalent of 50 mg LCPUFA). This was heated briefly to 70° C., and shaken to emulsify. The emulsion so formed did not have a fish taint at this level of incorporation.

In a similar manner to Example 6 above, milk and milk products can be enhanced by the dispersion of formulations such as A and H.

The formulations described above illustrate the way in which ω-3 PUFA can be introduced into dietary products without adversely affecting the taste and other organoleptic characteristics of nutritional products which are enriched with long chain PUFAs.

### Example 7

Methodology for Enhancing the Emulsifying Properties of e.g. Soya Flour.

100 grams of ‘Native’ Soya Flour was mixed to a stiff paste with 3 ml of 3 N Hydrochloric acid, and sufficient deionised water to control the pH to between 6.5 and 6.8. At this pH, lipases present in the flour are activated. The paste was left to incubate at a temperature of 32° C. for 2 hours before a solution of Sodium carbonate deca-hydrate (1.0 g dissolved in 3 mls water) was added, and mixed thoroughly, to neutralise the reaction. The pH of the resulting slurry was adjusted to pH 8.1 and the reaction stopped by heating to a temperature of 90-110° C. The paste was allowed to dry.

In commercial production, inactivation can be accomplished by drying on a heated roller to give a flaked product. Conventional and alternative methods of drying to give a granular product will be familiar to one skilled in the art.

The resulting product, referred to as AL-GMS, contains a mixture of mono & di-acyl glycerols and is suitable for incorporation in compositions as described in Table 2.

The activated lipase (AL) Soya flour (AL-GMS) contains acyl glycerol partial esters which replace the glyceryl monostearate and other acyl glycerol esters which would otherwise be added to that formulation. Other seed and bean flours (such as pea flour) contain lipases which can be activated to give similar hydrolysates.

The addition of Hydrochloric acid and neutralisation with a stoichometric quantity of Sodium carbonate (or sodium bicarbonate) leaves residual sodium chloride in the product. The amount of sodium chloride is below the range of salt which would be added in a conventional dough mix. The activation of lipase is dependent on the change of pH, and other acids (for example citric acid, other fruit acid, or acid phosphate) could be used.

Neutralisation (after incubation) can be effected using a nutritionally acceptable alkalising agent and preferably ammonium bicarbonate, calcium, or magnesium carbonate, or mixtures thereof. Use of these alternative electrolytes, which are nutritionally acceptable food components, for pH adjustment avoids adding to the toll of sodium and chloride in the product.

The resulting product when mixed with a marine oil, such as NL331A, and water at 35° C. when shaken emulsify to give a fine emulsion. It also has a less ‘beany’ taste than the starting material. Beneficially, a proportion of AL-GMS can replace native Soya flour in the formulations of the invention.

1. A substantially non aqueous additive mix in the form of a paste, for introducing poly unsaturated fatty acids into ingestible products, in which the one or more poly unsaturated fatty acids or a source thereof are not coated and/or spray dried and which when hydrated form an oil in water emulsion, comprising one or more poly unsaturated fatty acids, methyl esters thereof, or a source thereof, a farinaceous filler or viscosifying agent and one or more emulsifying agents.

2-43. (canceled)

44. An additive mix as claimed in claim 1 wherein the one or more poly unsaturated fatty acids or a source thereof are of marine origin.

45. An additive mix as claimed in claim 1 wherein, where the end product is a farinaceous product, the emulsifying agent is selected from mono, di and tri acyl glycerols and/or lecithins.

46. An additive mix as claimed in claim 1 wherein, where the end product is a farinaceous product, the emulsifying agent is a lecithin and the mix is free of added glycerol monostearate.

47. An additive mix as claimed in claim 45 wherein the acyl glycerols have a chain length of from C6 to C24.

48. An additive mix as claimed in claim 45 wherein the lecithin is an egg lecithin, milk lecithin, a Soya lecithin, native or heat treated, or a food component containing lecithin.

49. An additive mix as claimed in claim 1 wherein the unsaturated fatty acids or a source thereof are present in an amount of from 10 to 80% by weight, and the emulsifying agent is present in an amount of from 0.25 to 40% by weight.

50. An additive mix as claimed in claim 49 wherein the emulsifying agent is present in an amount of from 2.5 to 40% by weight.

51. An additive mix as claimed in claim 1 wherein the one or more poly unsaturated fatty acids, methyl esters thereof, or a source thereof are provided as fish oil.

52. An additive mix as claimed in claim 51 wherein the fish oil is one of a blended, pressed, deodorized, or concentrated fish oil.

53. An additive mix as claimed in claim 51 wherein the fish oil comprises at least 25% by weight the additive.

54. An additive mix as claimed in claim 1 wherein the one or more poly unsaturated fatty acids comprise EPA.

55. An additive mix as claimed in claim 1 wherein the one or more poly unsaturated fatty acids comprise DHA.

56. An additive mix as claimed in claim 1 wherein the one or more poly unsaturated fatty acids comprise DPA.

57. An additive mix as claimed in claim 1 wherein the one or more poly unsaturated fatty acids comprise ALA.

58. An additive mix as claimed in claim 1 wherein the one or more poly unsaturated fatty acids comprise SDA.

59. An additive mix as claimed in claim 1 wherein the one or more poly unsaturated fatty acids comprise Eicosatetraenoic acid (20:4 ω-3).

60. An additive mix as claimed in claim 1 comprising EPA and DHA in a ratio of from 0.01:1 to 8:1.

61. An additive mix as claimed in claim 1 wherein the emulsifying agent is selected to be an ingredient of an end product into which the additive mix will be added to provide a supplemental amount of one or more poly unsaturated fatty acids.

62. An additive mix as claimed in claim 1 further comprising as a viscosifier a hard fat.

63. An additive mix as claimed in claim 62 comprising by weight:
a. Fish oil 50%;
b. Lecithin 2.5%
c. Flour 26.4%
d. Hard fat 20%
e. Antioxidants 1.1%,
all present in a range of plus or minus 20% of the specified figures.

64. An additive mix as claimed in claim 1 having an antioxidant concentration of from 0.01% to 2%.

65. An additive mix as claimed in claim 64 wherein the antioxidant is selected from the group consisting of: mixed natural tocopherols (E306); dl-alpha-tocopherol (E307); other tocopherols; ascorbyl or sodium palmitate or stearate (E304 & E310); natural rosemary extract; an organic acid, such as citric acid (E330) or ascorbic acid (E300).

66. An additive mix as claimed in claim 1 having a viscosity of not more than 250 mPAs at 0° C. or 70 mPas at 25° C.

67. An additive mix as claimed in claim 1 wherein the viscosifying agent is present in an amount of up to 87.5% by weight.

68. An additive mix as claimed in claim 1 wherein the viscosifying agent is Soya flour.

69. An additive mix as claimed in claim 1 wherein the viscosifying agent is Vicia Faba Major (broad bean), Equina flour (horse bean) or gram flour (chick pea).

70. An additive mix as claimed in claim 1 further comprising a fortifying amount of one or more vitamins.

71. An additive mix as claimed in claim 70 wherein the one or more vitamins are fat soluble vitamins.

72. An additive mix as claimed in claim 70 wherein the vitamins comprise vitamin A, vitamin D, and Vitamin E.

73. An additive mix as claimed in claim 1 further comprising a fortifying amount of one or more minerals.

74. An additive mix as claimed in claim 73 wherein the minerals comprise a source of calcium, a source of magnesium and optionally one or more trace elements.

75. An ingestible product produced by addition of an additive mix as claimed in claim 1 thereto.

76. An ingestible product as claimed in claim 75 which is a farinaceous product.

77. An ingestible product as claimed in claim 75 which is bakery product or raised bakery product such as bread, pizza base, cake, muffin, doughnut, biscuit and morning goods.

78. An ingestible product as claimed in claim 75 which is an unleavened bakery product such as bread, biscuits, naan, chapattis, tortillas and wraps.

79. An ingestible product as claimed in claim 75 which is a fresh or dried dough such as pasta or noodles.

80. An ingestible product as claimed in claim 75 which is a beverage.

81. An ingestible product as claimed in claim 75 which is a dessert.

82. An additive mix as claimed in claim 1 packaged in a unit dosage form.

83. A method of fortifying an ingestible product with a PUFA comprising adding a substantially non aqueous additive mix as claimed in claim 1 during the processing of the ingestible product in an amount which will provide the finished product with a known amount of PUFA in a given weight or volume.

84. A method of generating a natural emulsifier from a farinaceous product comprising activating natural lipases present therein to generate a mixture of emulsifying mono and di-acyl glycerol esters from triglycerides naturally present therein.
